(19) United States
(12) Patent Application Publication
(10) Pub. No.: US 2026/0291616 A1
(43) Pub. Date: Sep. 24, 2026

(54) OPTICAL TRANSMITTER AND OPTICAL TRANSCEIVER

(71) Applicant: NEC Corporation, Tokyo (JP)

(72) Inventor: Kei IYODA, Tokyo (JP)

(73) Assignee: NEC Corporation, Tokyo (JP)

(21) Appl. No.: 19/560,343

(22) Filed: Mar. 9, 2026

(30) Foreign Application Priority Data
Mar. 19, 2025 (JP) 2025-045774

(51) Int. Cl. H04B 10/548; H04B 10/40

(52) U.S. Cl. CPC H04B 10/548; H04B 10/40

(57) ABSTRACT

A light source outputs light. A driver outputs first and second electric signals serving as a pair of differential electric signals according to an input data signal. A first attenuator attenuates the first electric signal by a first attenuation amount. A second attenuator attenuates the second electric signal by a second attenuation amount different from the first attenuation amount. A Mach-Zehnder optical modulator outputs an optical signal obtained by modulating the light output from the light source based on the first and second electric signals attenuated by the first and second attenuators, respectively.

### INCORPORATION BY REFERENCE

This application is based upon and claims the benefit of priority from Japanese patent application No. 2025-045774, filed on Mar. 19, 2025, the disclosure of which is incorporated herein in its entirety by reference.

### TECHNICAL FIELD

The present disclosure relates to an optical transmitter and an optical transceiver.

### BACKGROUND ART

An optical transmitter including small form-factor pluggable (SFP) commonly includes a laser light source, a modulator driver for outputting a differential signal, and an optical modulator. This optical transmitter outputs an optical signal by modulating, using the optical modulator, coherent light output from the light source according to the differential signal. The laser light source and the optical modulator including the SFP may be monolithically integrated by silicon (Si) photonics technology, and may be mass-produced. The optical signal output from the optical transmitter propagates through a single-mode optical fiber, and reaches the reception-side SFP. At this time, the transmitted optical signal is affected by dispersion, which causes distortion in a waveform.

In order to suppress the waveform distortion caused by the dispersion after transmission, it is conceivable to apply pre-chirping to the waveform of the optical signal on the transmission side or to electrically perform dispersion compensation on the reception side. For example, Japanese Unexamined Patent Application Publication No. 2023-172092 proposes a method of applying desired pre-chirping to an optical signal by setting a splitting ratio of an optical input/output splitting waveguide to an appropriate value in a Mach-Zehnder optical modulator configured as a Si photonics element. According to this method, the splitting ratio of the optical input/output splitting waveguide is set in such a way that an a parameter representing the pre-chirping is set to a negative value. As a result, if the electric dispersion compensation on the reception side is not performed, optical transmission up to approximately 15 km may be performed in C-band transmission at a data rate of 25 Gbit/s by the optical transmitter using the Mach-Zehnder optical modulator configured as the Si photonics element.

### SUMMARY

However, in recent optical communication networks, it is required to perform optical transmission over a longer distance than 15 km, for example, approximately 40 km. On the other hand, according to the method disclosed in Japanese Unexamined Patent Application Publication No. 2023-172092, it is difficult to achieve the optical transmission over a longer distance of approximately 40 km even if the electric dispersion compensation is performed on the reception side.

An optical transmitter according to an example aspect of the present disclosure includes a light source that outputs light, a drive means for outputting first and second electric signals serving as a pair of differential electric signals according to an input data signal, a first attenuation means for attenuating the first electric signal by a first attenuation amount, a second attenuation means for attenuating the second electric signal by a second attenuation amount different from the first attenuation amount, and a Mach-Zehnder optical modulator for outputting an optical signal obtained by modulating the light output from the light source based on the first and second electric signals attenuated by the first and second attenuation means, respectively.

According to the present disclosure, an optical transmitter and an optical transceiver capable of achieving long-distance optical transmission may be provided with a simple configuration.

### BRIEF DESCRIPTION OF THE DRAWINGS

FIG. 1 is a block diagram schematically illustrating a configuration of an optical transceiver;

FIG. 2 is a block diagram schematically illustrating a configuration of an optical transmitter according to an example embodiment;

FIG. 3 is a diagram schematically illustrating a configuration of a Mach-Zehnder optical modulator according to an example embodiment;

FIG. 4 illustrates an actual measurement example of a relationship between an a parameter and positive dispersion tolerance at a wavelength of 1,550 nm;

FIG. 5 is a diagram illustrating a relationship between a difference between attenuation amounts in two attenuators and the α parameter; and

FIG. 6 is a diagram illustrating a relationship between the difference between attenuation amounts in two attenuators and transmission characteristics of an optical signal.

### EXAMPLE EMBODIMENT

Hereinafter, example embodiments of the present invention will be described with reference to the drawings. In the drawings, the same elements are denoted by the same reference signs, and redundant description will be omitted as necessary.

Hereinafter, the term “an example embodiment” means that it is applicable to any of the example embodiments described below or to a combination of equal to or more than two example embodiments, and that the application is not limited to a specific example embodiment.

### First Example Embodiment

An optical transmitter according to the present example embodiment will be described. The optical transmitter according to the present example embodiment is mounted on an optical transceiver together with an optical receiver, for example. The optical transmitter is configured to transmit an optical signal modulated by a Mach-Zehnder optical modulator.

FIG. 1 is a block diagram schematically illustrating a configuration of the optical transceiver. An optical transceiver 1000 is configured as a pluggable optical module, such as an SFP optical transceiver. The optical transceiver 1000 includes an optical transmitter 100, an optical receiver 101, and a control unit 102. The control unit 102 is capable of controlling operations of the optical transmitter 100 and optical receiver 101. The optical transmitter 100 outputs an optical signal LT modulated based on a transmission data signal DT, which is an electric signal input from an external optical communication device or the like. The optical receiver 101 receives an optical signal LR input to the optical transceiver 1000 via an optical cable or the like, and outputs a reception data signal DR, which is an electric signal obtained by decoding the optical signal LR, to an external optical communication device, for example.

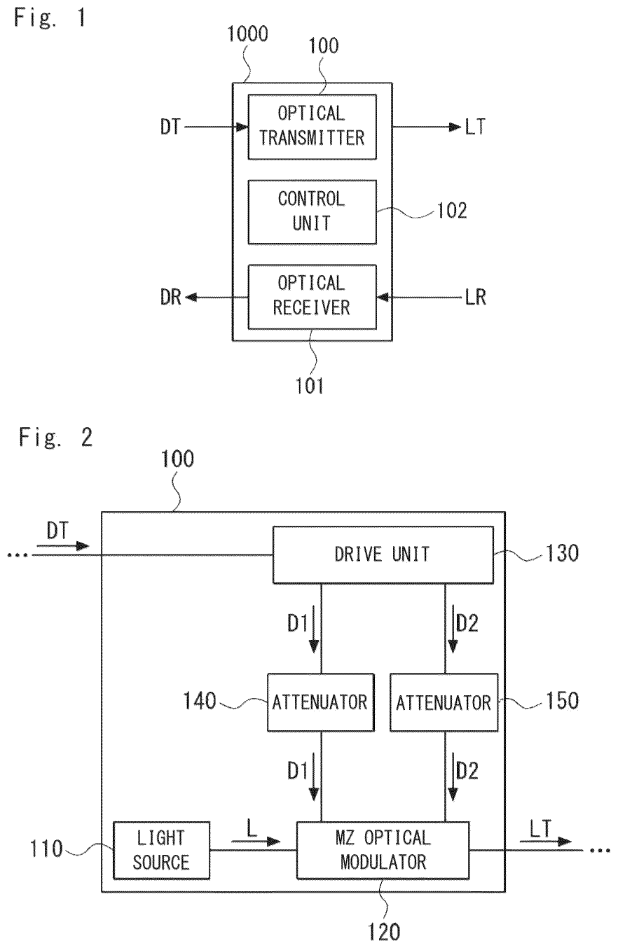

FIG. 2 is a block diagram schematically illustrating a configuration of an optical transmitter according to an example embodiment. The optical transmitter 100 includes a light source 110, a Mach-Zehnder optical modulator 120, a drive unit 130, and attenuators 140 and 150.

The light source 110 outputs light L having a predetermined wavelength to the Mach-Zehnder optical modulator 120. The light source 110 may be configured as, for example, a wavelength-tunable laser module capable of outputting laser light having a wavelength in a certain range as the light L.

The drive unit 130 outputs electric signals D1 and D2, which are differential drive signals for driving the Mach-Zehnder optical modulator 120, based on the input transmission data signal DT. Each of the electric signals D1 and D2 includes a bias component for controlling an operating point of the Mach-Zehnder optical modulator 120 and a modulation component for modulating light. The electric signals D1 and D2 are attenuated by the attenuators 140 and 150, and then input to the Mach-Zehnder optical modulator 120. Various attenuators may be used as the attenuators 140 and 150 as long as the electric signals D1 and D2 may be attenuated. For example, the attenuators 140 and 150 may be chip-type attenuators or resistors. Hereinafter, the attenuators 140 and 150 will also be referred to as first and second attenuators or first and second attenuation means, respectively. The electric signals D1 and D2 will also be referred to as first and second electric signals, respectively. Attenuation amounts of the electric signals D1 and D2 in the attenuators 140 and 150 will also be referred to as first and second attenuation amounts, respectively.

The Mach-Zehnder optical modulator 120 outputs the optical signal LT obtained by modulating the light L from the light source 110 based on the electric signals D1 and D2. Hereinafter, the Mach-Zehnder optical modulator will also be referred to as an MZ optical modulator.

Next, the Mach-Zehnder optical modulator 120 will be described. Here, an example will be described in which a splitting ratio of an input-side splitting unit and a splitting ratio of an output-side splitting unit of the Mach-Zehnder optical modulator 120 may be set.

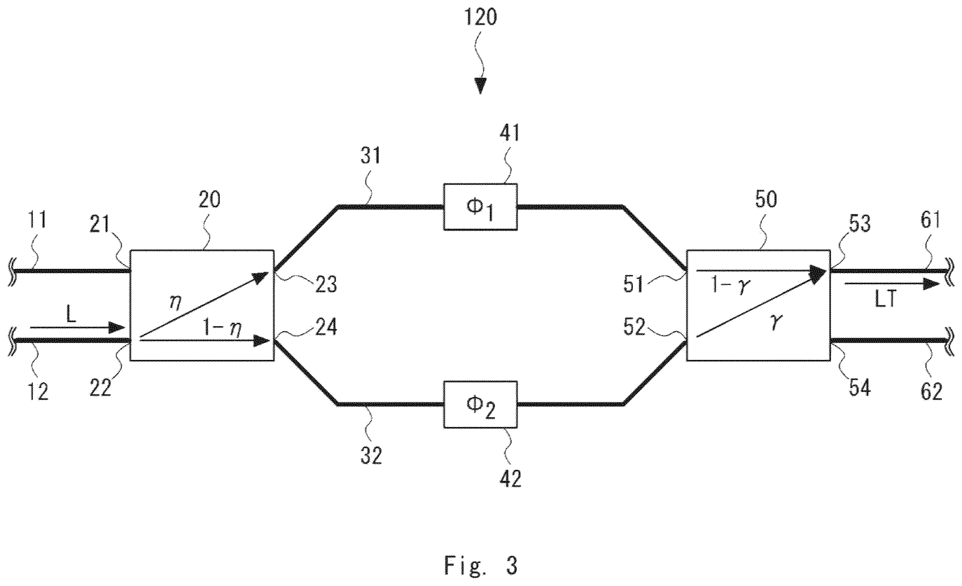

FIG. 3 is a diagram schematically illustrating a configuration of a Mach-Zehnder optical modulator according to an example embodiment. The Mach-Zehnder optical modulator 120 includes input waveguides 11 and 12, an input-side splitting unit 20, arms 31 and 32, phase modulation units 41 and 42, an output-side splitting unit 50, and output waveguides 61 and 62.

The input-side splitting unit 20 is a two-input two-output optical splitting unit having two input ports 21 and 22 and two output ports 23 and 24. In the present configuration, the input-side splitting unit 20 is configured as a directional coupler, and will also be referred to as a first directional coupler. The input waveguides 11 and 12 are connected to the input ports 21 and 22, respectively. It is assumed here that the light L is input from the input waveguide 12 to the input port 22. One end of the arm 31 is output to the output port 23 serving as a bar port with respect to the input port 21 connected to the input waveguide 11. One end of the arm 32 is output to the output port 24 serving as a bar port with respect to the input port 22 connected to the input waveguide 12.

The arms 31 and 32 configured as optical waveguides are respectively provided with phase modulation units 41 and 42 capable of adjusting a phase of passing light. The phase modulation units 41 and 42 are configured as electrodes, which are provided on the arms 31 and 32 and to which the electric signals D1 and D2 are respectively applied from the attenuators 140 and 150. Hereinafter, the arms 31 and 32 will also be referred to as first and second arms, respectively. The phase modulation units 41 and 42 will also be referred to as first and second modulation units or first and second modulation means, respectively.

The output-side splitting unit 50 is a two-input two-output optical splitting unit having two input ports 51 and 52 and two output ports 53 and 54. In the present configuration, the output-side splitting unit 50 is configured as a directional coupler, and will also be referred to as a second directional coupler. The output waveguides 61 and 62 are connected to the output ports 53 and 54, respectively. Another end of the arm 31 is connected to the input port 51 serving as a bar port with respect to the output port 53 to which the output waveguide 61 is connected. Another end of the arm 32 is connected to the input port 52 serving as a bar port with respect to the output port 54 to which the output waveguide 62 is connected.

In the Mach-Zehnder optical modulator 120, the modulated optical signal LT is output from the output port 53 of the output-side splitting unit 50 serving as a cross port with respect to the input port 22 of the input-side splitting unit 20 to which the optical signal is input.

In the present example embodiment, in the configuration described above, an optical signal that has been subjected to pre-chirping in advance is transmitted to apply tolerance to wavelength dispersion (which will be referred to as positive dispersion tolerance hereinafter) to the optical signal transmitted through a transmission path. Hereinafter, the application of the positive dispersion tolerance in the Mach-Zehnder optical modulator 120 will be described. According to the present example embodiment, desired positive dispersion tolerance may be achieved by adjusting a transmission characteristic of the Mach-Zehnder optical modulator 120, specifically, what is called a chirp parameter. The chirp parameter is a value also referred to as an a parameter, and hereinafter, it is assumed that the α parameter refers to the chirp parameter.

[Relationship between a Parameter and Positive Dispersion Tolerance]

A relationship between the α parameter and the positive dispersion tolerance in the Mach-Zehnder optical modulator 120 will be described. The α parameter represents a phase modulation effect associated with intensity modulation, and is expressed as a formula [1] as a time variation of an electric field phase Φ divided by a time variation of electric field amplitude E (F. Koyama and K. Iga, “Frequency Chirping in External Modulators”, Jan. 1988, J. Light. Technol., vol. 6, no. 1, pp. 87-93). P in the formula [1] represents a value obtained by squaring the electric field E, and indicates power of the electric field E.

$$\begin{matrix}[ Math . 1 ] & \\ α = \frac{\frac{d Φ}{dt}}{\frac{1}{E} \frac{dE}{dt}} = \frac{2 P \frac{d Φ}{t}}{\frac{dP}{dt}} & [ 1 ]\end{matrix}$$

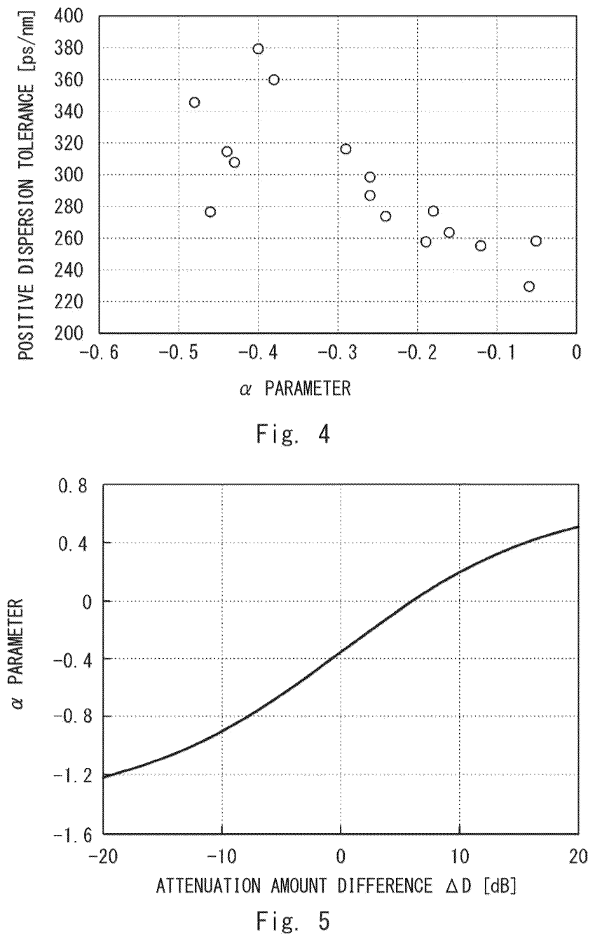

FIG. 4 illustrates an actual measurement example of the relationship between the α parameter and the positive dispersion tolerance at a wavelength of 1,550 nm. As illustrated in FIG. 4, it can be seen to be sufficient if the α parameter is set to a negative value and its absolute value is increased to obtain the positive dispersion tolerance. While the sign of wavelength dispersion of a single mode fiber (SMF) varies depending on a wavelength to be used, it may be seen to be sufficient from FIG. 4 if the value of the α parameter is made negative to obtain the positive dispersion tolerance at the wavelength of 1,550 nm.

### [Formulation of α Parameter]

As disclosed in Japanese Unexamined Patent Application Publication No. 2023-172092, the α parameter may be expressed as a function of a splitting ratio of one or both of the input-side splitting unit and the output-side splitting unit of the Mach-Zehnder optical modulator and the bias components of the electric signals D1 and D2.

As illustrated in FIG. 3, in the Mach-Zehnder optical modulator 120, a cross port power splitting ratio of the input-side splitting unit 20 is set to η (0≤η≤1) and a cross port power splitting ratio of the output-side splitting unit 50 is set to γ (0≤γ≤1). Specifically, in the input-side splitting unit 20, a signal passing rate from the input port 22 to the output port 23 is η, and a signal passing rate from the input port 22 to the output port 24 is 1−η. In the output-side splitting unit 50, a signal passing rate from the input port 51 to the output port 53 is 1−γ, and a signal passing rate from the input port 52 to the output port 53 is γ. Hereinafter, it is assumed that a power splitting ratio is indicated in a case of simply being referred to as a splitting ratio. Hereinafter, a cross port power splitting ratio will also be simply referred to as a cross port splitting ratio, and a bar port power splitting ratio will also be simply referred to as a bar port splitting ratio.

An output electric field E_{OUT} of the cross port output of the Mach-Zehnder optical modulator is expressed as the following formulae [2] to [4]. In the formula [2], Φ₁ and Φ₂ represent phase change amounts caused by the arms 31 and 32, respectively. In the formula [2], a₁ and a₂ represent coefficients of bias voltage included in the electric signals D1 and D2 that vary with time in the phase modulation units 41 and 42, respectively, and the term of the bias voltage multiplied by the coefficients indicates an amplitude of a component that varies with time in the phase change amount. Φ_{B1} and Φ_{B2} represent components that do not vary with time in the phase change amount caused by the bias voltage in the phase modulation units 41 and 42, respectively. E_{IN} represents an electric field of light input to the Mach-Zehnder optical modulator (T. Kawanishi, K. Kogo, S. Oikawa, M. Izutsu, “Direct measurement of chirp parameters of high-speed Mach-Zehnder-type optical modulators”, Aug. 2001, Optics Communications, vol. 195, pp399-404, H. Kim and A. Gnauck, “Chirp Characteristics of Dual-Drive Mach-Zehnder Modulator With a Finite DC Extinction Ratio”, Mar. 2002, IEEE Photonics Technol. Lett., vol. 14, no. 3, pp. 298-300, Y. Yamaguchi, A. Kanno, T. Kawanishi, M. Izutsu and H. Nakajima, “Precise Optical Modulation Using Extinction-Ratio and Chirp Tunable Single-Drive Mach-Zehnder Modulator”, Nov. 2017, J. Light. Technol., vol. 35, no. 21, pp. 4781-4788, and Y. Yamaguchi, “Advanced Optical Modulator Based on Integrated Mach-Zehnder Interferometer”, 2017, Doctoral Dissertation, Waseda University).

$$\begin{matrix}[ Math . 2 ] & \\ {E}_{O U T} = \{ \sqrt{η ( 1 - γ )} {e}^{j {Φ}_{1}} + \sqrt{( 1 - η ) γ} {e}^{j {Φ}_{2}} \} \text{} {E}_{IN} \text{} {e}^{j ω t} = [ \{ \sqrt{η ( 1 - γ )} cos {Φ}_{1} + \sqrt{( 1 - η ) γ} cos {Φ}_{2} \} + j \{ \sqrt{η ( 1 - γ )} sin {Φ}_{1} + \sqrt{( 1 - η ) γ} sin {Φ}_{2} \} ] {E}_{IN} {e}^{j ω t} & [ 2 ]\end{matrix}$$

$$\begin{matrix}[ Math . 3 ] & \\ {Φ}_{1} = {a}_{1} V ( t ) + {Φ}_{B 1} & [ 3 ]\end{matrix}$$

$$\begin{matrix}[ Math . 4 ] & \\ {Φ}_{2} = {a}_{2} V ( t ) + {Φ}_{B 2} & [ 4 ]\end{matrix}$$

According to the formula [2], the power P of the output electric field E_{OUT} and the phase Φ of the electric field may be expressed as the following formulae [5] and [6], respectively.

$$\begin{matrix}[ Math . 5 ] & \\ P = {⌊ {E}_{O U T} ⌋}^{2} = \{ η ( 1 - γ ) + ( 1 - η ) γ + 2 \sqrt{η ( 1 - η ) γ ( 1 - γ )} cos ( {Φ}_{1} - {Φ}_{2} ) \} {E}_{I {N}^{2}} & [ 5 ]\end{matrix}$$

$$\begin{matrix}[ Math . 6 ] & \\ Φ = {tan}^{- 1} ( \frac{\sqrt{η ( 1 - γ )} sin {Φ}_{1} + \sqrt{( 1 - η ) γ} sin {Φ}_{2}}{\sqrt{η ( 1 - γ )} cos {Φ}_{1} + \sqrt{( 1 - η ) γ} c o s {Φ}_{2}} ) & [ 6 ]\end{matrix}$$

If the formulae [5] and [6] are substituted into the formula [1], the α parameter may be expressed as the following formula [7].

$$\begin{matrix}[ Math . 7 ] & \\ α = - \frac{1}{sin ( {Φ}_{1} - {Φ}_{2} )} \{ \frac{1}{\sqrt{η ( 1 - η ) γ ( 1 - γ )}} \frac{η ( 1 - γ ) {a}_{1} + ( 1 - η ) γ {a}_{2}}{{a}_{1} - {a}_{2}} + \frac{{a}_{1} + {a}_{2}}{{a}_{1} - {a}_{2}} cos ( {Φ}_{1} - {Φ}_{2} ) \} & [ 7 ]\end{matrix}$$

As may be seen from the formula [7], the α parameter changes depending on the splitting ratio η of the input-side splitting unit 20 of the Mach-Zehnder optical modulator 120, which is a Mach-Zehnder optical modulator, the splitting ratio γ of the output-side splitting unit 50, and the coefficients a₁ and a₂ of the bias components of the electric signals D1 and D2. In Japanese Unexamined Patent Application Publication No. 2023-172092, it is assumed that a₁ and a₂ representing the amplitudes of the bias components of the electric signals D1 and D2 are equal to each other.

In Japanese Unexamined Patent Application Publication No. 2023-172092, the splitting ratio η of the input-side splitting unit 20 and the splitting ratio γ of the output-side splitting unit 50 are suitably set, whereby light transmission is enabled up to 15 km. However, it is difficult to apply pre-chirping to optical signals in such a way that the light transmission of equal to or more than 15 km is enabled only by setting the splitting ratio η of the input-side splitting unit 20 and the splitting ratio γ of the output-side splitting unit 50.

In view of the above, in the present example embodiment, the attenuators 140 and 150 are inserted between the drive unit 130 and the Mach-Zehnder optical modulator 120. With this arrangement, the electric signals D1 and D2 output from the drive unit 130 are attenuated by the attenuators 140 and 150, respectively, and then reach the Mach-Zehnder optical modulator 120. At this time, with the attenuation amount in the attenuator 140 and the attenuation amount in the attenuator 150 being differentiated, the coefficients a₁ and a₂ of the bias components of the electric signals D1 and D2 may be unbalanced.

As described above, it is sufficient if the α parameter is set to a negative value to improve the positive dispersion tolerance. Meanwhile, in the optical transmitter 100, the attenuation amounts in the attenuators 140 and 150 are suitably set to adjust the values of a₁ and a₂, whereby the α parameter may be set to a negative value. As long as the α parameter may be set to a negative value in the optical transmitter 100, the attenuation amount of one of the attenuators 140 and 150 may be set to 0, and the attenuation amount of the other may be set to a predetermined attenuation amount other than 0.

If the attenuation amount of one of the attenuators 140 and 150 is set to 0, it is conceivable not to provide an attenuator having the attenuation amount of 0. However, if the attenuator is inserted into only one of the two transmission paths for transmitting the electric signals D1 and D2, line lengths of the two transmission paths are made different from each other. As a result, the timing at which the electric signals D1 and D2 are input to the Mach-Zehnder optical modulator 120 varies, which may adversely affect the modulation operation of the Mach-Zehnder optical modulator 120. On the other hand, with the attenuators having similar configurations being inserted into the two transmission paths for transmitting the electric signals D1 and D2, the line lengths of the two transmission paths may be made equal to each other. As a result, the timing at which the electric signals D1 and D2 are input to the Mach-Zehnder optical modulator 120 may be matched with each other.

The attenuation amounts of the attenuators 140 and 150 may be fixed or variable. If the attenuation amounts of the attenuators 140 and 150 are variable, the value of the α parameter may be changed afterward depending on the application.

Next, a relationship between the α parameter and a difference between the attenuation amount of the electric signal D1 in the attenuator 140 and the attenuation amount of the electric signal D2 in the attenuator 150 will be described. FIG. 5 is a diagram illustrating the relationship between the α parameter and the difference between the attenuation amounts in the two attenuators. It is assumed here that a value obtained by subtracting the attenuation amount of the electric signal D2 in the attenuator 150 from the attenuation amount of the electric signal D1 in the attenuator 140 is an attenuation amount difference ΔD. As illustrated in FIG. 5, with the attenuation amount difference ΔD being appropriately set, the α parameter may be set to a negative value as described with reference to FIG. 4. In addition, with the absolute value of the negative α parameter being increased, higher positive dispersion tolerance may be achieved.

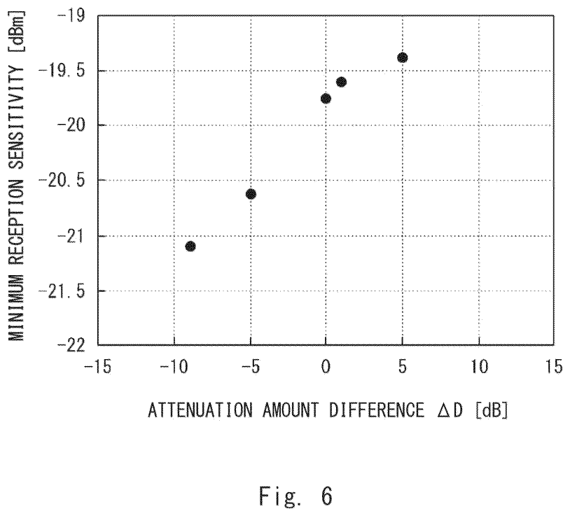

FIG. 6 is a diagram illustrating a relationship between the difference between the attenuation amounts in the two attenuators and transmission characteristics of an optical signal. As illustrated in FIG. 6, with the attenuation amount difference ΔD being set to a negative value, the minimum reception sensitivity may be reduced. That is, it may be seen that an increase in the absolute value of the negative α parameter may enable reduction of the minimum reception sensitivity in a reception-side device after 40 km transmission. That is, with the value of the α parameter being set to a negative value based on setting of the attenuation amount difference ΔD, the positive dispersion tolerance that may withstand the optical transmission of 40 km may be achieved.

As in Japanese Unexamined Patent Application Publication No. 2023-172092, the light transmission exceeding 15 km may be achieved by adjusting the splitting ratio η of the input-side splitting unit 20 and the splitting ratio γ of the output-side splitting unit 50 of the Mach-Zehnder optical modulator 120. However, in that case, the design of the input-side splitting unit 20 and the output-side splitting unit 50 needs to be changed. Thus, a Si photonics device on which the Mach-Zehnder optical modulator 120 is mounted needs to be manufactured each time of the design change. A large number of the Si photonics devices are collectively manufactured by arranging a large number of devices of the same design on a semiconductor wafer. Thus, it is not easy to reflect the design change in a process, and significant effort and cost are required. If a desired number of the devices is small, the cost per device increases.

Meanwhile, according to the optical transmitter according to the present example embodiment, desired pre-chirping may be achieved only by provision of the two attenuators without changing the design of the Mach-Zehnder optical modulator 120. Thus, as compared with the case of changing the design of the Mach-Zehnder optical modulator 120, the optical transmitter capable of applying the desired pre-chirping to the optical signal may be easily achieved at low cost.

Since the desired pre-chirping may be achieved only by the provision of the two attenuators in the optical transmitter 100, a demand for miniaturization of the optical transmitter 100 may also be easily satisfied.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

The configuration of the Mach-Zehnder optical modulator 120 described above is merely an example. For example, it may be configured as an optical modulator in which equal to or more than two Mach-Zehnder interferometers having two arms are combined. Then, as in the example embodiment described above, electric signals attenuated by two attenuators may be applied to two arms of a desired Mach-Zehnder interferometer among the equal to or more than two Mach-Zehnder interferometers.

In the example embodiment described above, it has been described that the electric signals D1 and D2 are attenuated by the attenuators 140 and 150 to adjust the α parameter to achieve the desired pre-chirping. However, as proposed in Japanese Unexamined Patent Application Publication No. 2023-172092, a method based on a splitting ratio of the input-side splitting unit 20 and the output-side splitting unit 50 of the Mach-Zehnder optical modulator 120 may be used to adjust the α parameter to achieve the desired pre-chirping. That is, the adjustment of the α parameter based on the attenuation of the electric signals D1 and D2 using the attenuators 140 and 150 and the adjustment of the α parameter based on the splitting ratio of the input-side splitting unit 20 and the output-side splitting unit 50 of the Mach-Zehnder optical modulator 120 may be used in combination.

Each of the drawings is merely an example for explaining one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment not explicitly illustrated or described. All of the features or steps illustrated in any one of the drawings for explaining illustrative example embodiments are not necessarily mandatory, and some features or steps may be omitted. The order of the steps described in any of the drawings may be changed as appropriate.

Some or all of the example embodiments described above may also be described as, but are not limited to, the following Supplementary Notes.

### Supplementary Note 1

An optical transmitter including:
a light source that outputs light;
a drive means for outputting first and second electric signals serving as a pair of differential electric signals according to an input data signal;
a first attenuation means for attenuating the first electric signal by a first attenuation amount;
a second attenuation means for attenuating the second electric signal by a second attenuation amount different from the first attenuation amount; and
a Mach-Zehnder optical modulator for outputting an optical signal obtained by modulating the light output from the light source based on the first and second electric signals attenuated by the first and second attenuation means, respectively.

### Supplementary Note 2

The optical transmitter according to Supplementary Note 1, in which the Mach-Zehnder optical modulator includes:
first and second arms including an optical waveguide;
an optical splitting means for splitting the light output from the light source to the first and second arms; and
first and second modulation means for performing phase modulation on lights propagating through the first and second arms by the first and second electric signals attenuated by the first and second attenuation means being input, the first and second modulation means being provided in the first and second arms, respectively.

### Supplementary Note 3

The optical transmitter according to Supplementary Note 2, in which the first and second modulation means include electrodes provided in the first and second arms to which the first and second electric signals attenuated by the first and second attenuation means are applied, respectively.

### Supplementary Note 4

The optical transmitter according to Supplementary Note 3, in which bias components of different magnitudes included in the first and second electric signals attenuated by the first and second attenuation means are applied to the first and second arms, respectively.

### Supplementary Note 5

The optical transmitter according to any one of Supplementary Notes 1 to 4, in which one of the first and second attenuation amounts is 0.

### Supplementary Note 6

The optical transmitter according to any one of Supplementary Notes 1 to 5, in which the first and cond attenuation amounts are determined according to pre-chirping applied to the optical signal output from the Mach-Zehnder optical modulator.

### Supplementary Note 7

An optical transceiver including:
the optical transmitter according to any one of Supplementary Notes 1 to 6 that transmits the optical signal to a communication partner; and
an optical receiver that receives an optical signal transmitted by the communication partner.

Some or all of the elements (such as configurations and functions, for example) described in Supplementary Notes 2 to 6 dependent on Supplementary Note 1 may be dependent on Supplementary Note 7 as well with dependent relationships similar to those of Supplementary Notes 2 to 6. Some or all of the elements described in any supplementary note may be applied to various types of hardware, software, recording means for recording software, systems, and methods.

1. An optical transmitter comprising:
a light source that outputs light;
a driver that outputs first and second electric signals serving as a pair of differential electric signals according to an input data signal;
a first attenuator that attenuates the first electric signal by a first attenuation amount;
a second attenuator attenuates the second electric signal by a second attenuation amount different from the first attenuation amount; and
a Mach-Zehnder optical modulator that outputs an optical signal obtained by modulating the light output from the light source based on the first and second electric signals attenuated by the first and second attenuators, respectively.

2. The optical transmitter according to claim 1, wherein the Mach-Zehnder optical modulator includes:
first and second arms including an optical waveguide;
an optical splitter that splits the light output from the light source into the first and second arms; and
first and second modulators that perform phase modulation on lights propagating through the first and second arms by the first and second electric signals attenuated by the first and second attenuators being input, the first and second modulators being provided in the first and second arms, respectively.

3. The optical transmitter according to claim 2, wherein the first and second modulators include electrodes provided in the first and second arms to which the first and second electric signals attenuated by the first and second attenuators are applied, respectively.

4. The optical transmitter according to claim 3, wherein bias components of different magnitudes included in the first and second electric signals attenuated by the first and second attenuators are applied to the first and second arms, respectively.

5. The optical transmitter according to claim 1, wherein one of the first and second attenuation amounts is 0.

6. The optical transmitter according to claim 1, wherein the first and second attenuation amounts are determined according to pre-chirping applied to the optical signal output from the Mach-Zehnder optical modulator.

7. An optical transceiver comprising:
the optical transmitter according to claim 1 that transmits the optical signal to a communication partner; and
an optical receiver that receives an optical signal transmitted by the communication partner.
